(19) United States
(12) Patent Application Publication
(10) Pub. No.: US 2006/0221014 A1
(43) Pub. Date: Oct. 5, 2006

(54) Organic light emitting display and method of driving the same

(75) Inventors: Young Jong Park, Seoul (KR); Kyoung Soo Lee, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd.

(21) Appl. No.: 11/365,829

(22) Filed: Mar. 2, 2006

(30) Foreign Application Priority Data
Mar. 31, 2005 (KR) 10-2005-27332

(51) Int. Cl. G09G 3/30

(52) U.S. Cl. 345/77

(57) ABSTRACT

An organic light emitting display, and a method of driving the same, including a pixel unit having pixels to display images and a brightness controller to restrict the brightness of the pixel unit. The brightness controller generates frame data by summing the video data in one frame so that the brightness of the pixel unit is restricted when the value of the frame data is no less than a predetermined value and so that the brightness of the pixel unit is not restricted when the value of the frame data is no more than a predetermined value.

### CROSS-REFERENCE TO RELATED APPLICATIONS

This application claims priority to and the benefit of Korean Patent Application No. 10-2005-0027332, filed on Mar. 31, 2005, which is hereby incorporated by reference for all purposes as if fully set forth herein.

### BACKGROUND OF THE INVENTION

1. Field of the Invention

The present invention relates to an organic light emitting display and a method of driving the same, and more particularly, to an organic light emitting display that may restrict its brightness and a method of driving the same.

2. Discussion of the Background

Various thin and lightweight flat panel displays have been recently developed to replace cathode ray tubes (CRT). Light emitting displays, which have high emission efficiency, brightness, and response speed, as well as large viewing angles, are particularly receiving a lot of attention.

Light emitting displays may be organic displays, which use organic light emitting diodes (OLED), and inorganic displays, which use inorganic light emitting diodes (LED). The OLED includes an anode, a cathode, and an organic emission layer arranged between the anode and the cathode to emit light by combination of electrons and holes. Unlike the OLED, the inorganic LED includes an emission layer formed of inorganic material such as a PN-junction semiconductor.

FIG. 1 shows the structure of a conventional organic light emitting display. Referring to FIG. 1, the conventional organic light emitting display includes a pixel unit 10, a data driver 20, a scan driver 30, and a power source supply unit 40.

The pixel unit 10 includes a plurality of pixels 11 having an OLED (not shown), n scan lines S1, S2, . . . , Sn-1, and Sn arranged in a row direction to transmit scan signals, m data lines D1, D2, . . . , Dm-1, and Dm arranged in a column direction to transmit data signals, m first power source supply lines to transmit a first power source ELVdd, and m second power source supply lines to transmit a second power source ELVss, which has a lower potential than the first power source ELVdd. The pixel unit 10 emits light from the OLEDs by the scan signals, the data signals, the first power source ELVdd, and the second power source ELVss to display images.

The data driver 20 applies data signals to the pixel unit 10 via the data lines D1, D2, . . . , Dm-1, and Dm.

The scan driver 30 sequentially supplies scan signals to the scan lines S1, S2, . . . , Sn-1, and Sn (i.e. to the specific rows of the pixel unit 10). The data signals from the data driver 20 are applied to the specific rows of the pixel unit 10 to which the scan signals are supplied to display images. One frame is completed after all rows of the pixel unit 10 have been selected.

The power source supply unit 40 transmits the first power source ELVdd and the second power source ELVss to the pixel unit 10 so that the currents corresponding to the data signals may flow through the pixels 10 by the difference in voltage between the first power source ELVdd and the second power source ELVss.

In an organic light emitting display having such a structure, a large amount of currents flow through the pixel unit 10 when the pixel unit 10 emits bright light, and a small amount of currents flow through the pixel unit 10 when it emits duller light. Here, when the large amount of currents flow through the pixel unit 10, a large load is applied to the power source supply unit 40, which may require the power source supply unit 40 to have high outputs.

Also, when the small amount of currents flow through the pixel unit 10, the contrast of the light emitting display may deteriorate.

### SUMMARY OF THE INVENTION

The present invention provides an organic light emitting display in which the amount of currents that flow may be restricted to reduce brightness and power consumption, thereby improving picture quality, as well as a method of driving the same.

Additional features of the invention will be set forth in the description which follows, and in part will be apparent from the description, or may be learned by practice of the invention.

The present invention discloses an organic light emitting display including a pixel unit having pixels receiving scan signals, emission control signals, and data signals to display images, a brightness controller to restrict the brightness of the pixel unit, a scan driver to transmit is the scan signals and the emission control signals to the pixel unit, and a data driver to generate the data signals using video data and to transmit the data signals to the pixel unit. The brightness controller generates frame data by summing the video data in one frame, and the brightness of the pixel unit is restricted when the magnitude of the frame data is no less than a first value and is not restricted when the magnitude of the frame data is no more than a second value.

The present invention also discloses an organic light emitting display includig a pixel unit having pixels receiving scan signals, emission control signals, and data signals to display images, a brightness controller to restrict the brightness of the pixel unit, a scan driver to transmit the scan signals and the emission control signals to the pixel unit, and a data driver to generate the data signals using video data and to transmit the data signals to the pixel unit. The brightness controller generates frame data by summing the video data in one frame, and the amount that the brightness of the pixel unit is restricted varies with the magnitude of the frame data.

The present invention also discloses a method of driving an organic light emitting display including summing video data input in one frame, and restricting brightness of a pixel unit when the magnitude of the summed data is no less than a first level, and not restricting the brightness of the pixel unit when the magnitude of the summed data is no more than a second level.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a conventional organic light emitting display.

FIG. 2 shows an organic light emitting display according to an exemplary embodiment of the present invention.

FIG. 3 shows a brightness controller that may be used in the organic light emitting display of FIG. 2 according to an exemplary embodiment of the present invention.

FIG. 4A, FIG. 4B, FIG. 4C, and FIG. 4D show cases where current is restricted to 33% of the maximum current value of the organic light emitting display according to an exemplary embodiment of the present invention.

FIG. 5A, FIG. 5B, FIG. 5C, and FIG. 5D show cases where current is restricted to 50% of the maximum current value of the organic light emitting display according to an exemplary embodiment of the present invention.

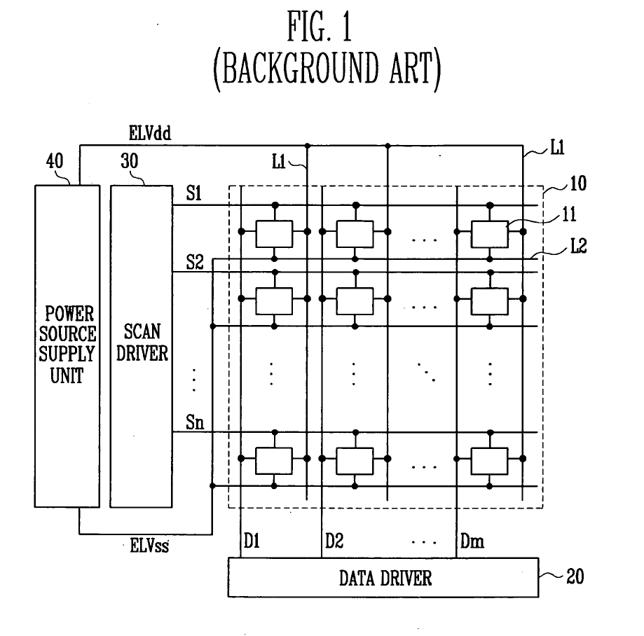

### DETAILED DESCRIPTION OF ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element such as a layer, film, region or substrate is referred to as being “on” another element, it can be directly on the other element or intervening elements may also be present. In contrast, when an element is referred to as being “directly on” another element, there are no intervening elements present.

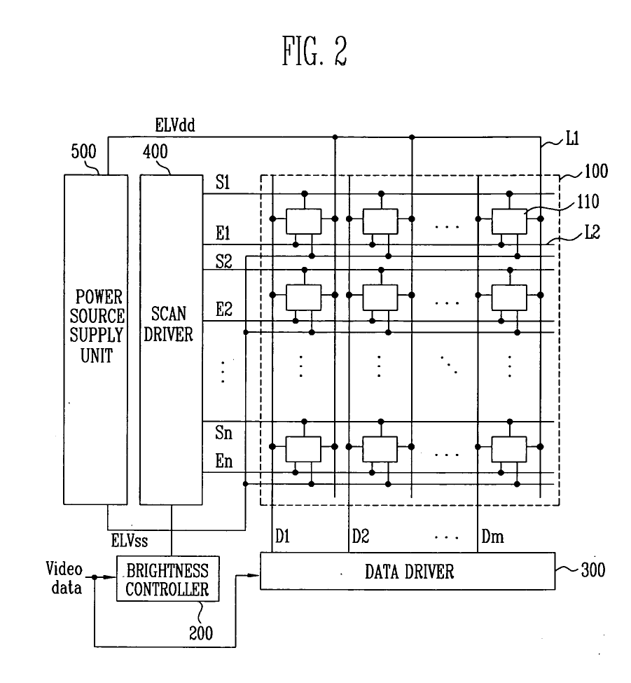

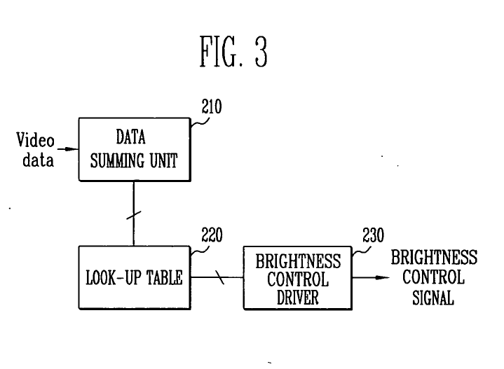

FIG. 2 shows an organic light emitting display according to an exemplary embodiment of the present invention. Referring to FIG. 2, the organic light emitting display includes a pixel unit 100, a brightness controller 200, a data driver 300, a scan driver 400, and a power source supply unit 500.

The pixel unit 100, which displays images, includes a plurality of pixels 110, n scan lines S1, S2, . . . , Sn-1, and Sn arranged in a row direction to transmit scan signals, n emission control signal lines E1, E2, . . . , En-1, and En arranged in a row direction to transmit emission control signals, m data lines D1, D2, . . . , Dm-1, and Dm arranged in a column direction to transmit data signals, first power source lines L1 to transmit a first power source ELVdd to the pixels 110, and second power source lines L2 to transmit a second power source ELVss to the pixels 110. Each pixel 110 includes an organic light emitting diode (OLED) (not shown). Here, instead of the second power source lines L2, a layer may be coupled with the second power source ELVss and arranged in the entire region of the pixel unit 100 to be electrically coupled with the pixels 110.

The brightness controller 200 outputs brightness control signals to restrict the brightness of the pixel unit 100 so that its brightness does not exceed a predetermined level. The brightness of the pixel unit 100 is higher when a large area of the pixel unit 100 emits bright light than when a small area of the pixel unit 100 emits bright light. For example, the pixel unit 100 is brighter when it emits light with full white than when it does not emit light with full white. Therefore, according to an exemplary embodiment of the present invention, when a large area of the pixel unit 100 emits bright light, the brightness of the pixel unit 100 may be reduced to a predetermined extent. The amount that the brightness of the pixel unit 100 is restricted varies with the area in which the pixel unit 100 emits bright light so that the brightness of the pixel unit 100 may change in accordance with the change in the area in which the pixel unit 100 emits bright light.

The brightness controller 200 captures the magnitude of frame data (i.e. the sum of video data signals input in one frame) to determine whether a large amount of currents flow through the pixel unit 100, which emits bright light when the magnitude of the frame data is large, or a small amount of currents flow through the pixel unit 100, which is the case when the magnitude of the frame data is small. Therefore, the brightness controller 200 outputs brightness control signals to restrict the brightness of the pixel unit 100 when the magnitude of the frame data is no less than a predetermined value to reduce the brightness of the images displayed by the pixel unit 100. Then, the images are displayed.

When the brightness controller 200 restricts the brightness of the pixel unit 100, the amount of currents that flow through the pixel unit 100 is restricted so that the power source supply unit 500 having high outputs may not be required. On the other hand, when the brightness of the pixel unit 100 is not restricted, the time for which the pixels emit light may be maintained longer so that the brightness of the pixel unit 100 relatively increases. Therefore, contrast between the pixels that emit light and the pixels that do not emit light may increase, which may improve contrast of the pixel unit 100.

Reducing the time for which the pixels emit light correspondingly reduces the time for supplying currents, thereby reducing the amount of currents that flow through the pixel unit 100.

In order to control the time for which the pixel unit 100 emits light in one frame, the brightness controller 200 may control the pulse widths of the emission control signals, which are transmitted through the emission control signal lines E1, E2, . . . , En-1, and En to control emission time. When the pulse widths are large, an increased amount of currents flow in the pixel unit 100 so that the entire brightness of the pixel unit 100 is not reduced. On the other hand, when the pulse widths are small, a small amount of currents flow in the pixel unit 100 so that the entire brightness of the pixel unit 100 is reduced.

The data driver 300, which applies data signals to the pixel unit 100, receives video data having red, blue, and green components and generates data signals. The data driver 300 is coupled with the data lines D1, D2, . . . , Dm-1, and Dm of the pixel unit 100 to apply the generated data signals to the pixel unit 100.

The scan driver 400 applies scan signals and emission control signals to the pixel unit 100 via the scan lines S1, S2, . . . , Sn-1, and Sn and the emission control signal lines E1, E2, . . . , En-1, and En, respectively. The data signals output from the data driver 300 are transmitted to the pixels 110 to which the scan signals are transmitted. Then the pixels 110 to which the emission control signals are transmitted emit light in accordance with the emission control signals.

The scan driver 400 may be divided into a scan driving circuit, which generates the scan signals, and an emission driving circuit, which generates the emission control signals. Hence, the scan driving circuit and the emission driving circuit may be included in one component, or they may be divided into separate components.

The data signals input from the data driver 300 are applied to the specific rows of the pixel unit 100 to which the scan signals are transmitted. The currents corresponding to the emission control signals and the data signals are transmitted to the OLEDs so that the OLEDs emit light to display images. Here, one frame is completed after sequentially selecting all rows (i.e. all scan lines).

The power source supply unit 500 transmits a first power source ELVdd and a second power source ELVss to the pixel unit 100 so that currents corresponding to the data signals may flow through the pixels due to the difference in voltage between the first power source ELVdd and the second power source ELVss.

FIG. 3 shows a brightness controller that may be used in the organic light emitting display of FIG. 2 according to an exemplary embodiment of the present invention. Referring to FIG. 3, the brightness controller 200 includes a data summing unit 210, a look-up table 220, and a brightness control driver 230.

The data summing unit 210 extracts information on frame data by summing the video data having information on red, blue, and green components that is input in one frame. A large magnitude of the frame data indicates a large number of data items that display high gray scales, and a small magnitude of the frame data indicates a small number of data items that display high gray scales.

The widths of the emission periods of the emission control signals are determined in accordance with the values of the frame data and the look-up table 220. The widths of the emission periods may be determined by the upper bits of the frame data. The brightness of the pixel unit 100 in one frame may be captured by the upper five bits of the frame data.

As the magnitude of the frame data increases, the brightness of the pixel unit 100 increases, and the brightness of the pixel unit 100 may be restricted when it is no less than a predetermined level. Furthermore, as the brightness of the pixel unit 100 increases, the restriction ratio may increase to prevent the brightness of the pixel unit 100 from excessively increasing.

When the brightness of the pixel unit 100 is uniformly restricted in accordance with the increase in the brightness of the pixel unit 100, the brightness may be excessively restricted when it is extremely high so that it may not be possible to provide a bright enough screen and the entire brightness may be reduced. The maximum restriction ratio of the brightness is previously set with respect to the brightness of when a frame represents white. Therefore, the brightness is not lowered more than the maximum restriction ratio.

According to an exemplary embodiment of the present invention, the images displayed by the light emitting display may be divided into still images and moving images and the amount of brightness restriction may vary with the type of image.

The brightness of the pixel unit 100 is not restricted when the magnitude of the frame data is no more than a predetermined level (i.e. when the brightness of the pixel unit 100 is not high).

TABLE 1 is the look-up table 220 in which the emission ratio is restricted to about 50% of the maximum value in accordance with the brightness of the pixel unit 100.

TABLE 1

| | | | | Widths of |
|---|---|---|---|---|
| Values of | Emission | Emission | Maximum | emission control |
| upper five bits | rate | ratio | brightness | signals |
| 0 | 0% | 100% | 300 | 325 |
| 1 | 4% | 100% | 300 | 325 |
| 2 | 7% | 100% | 300 | 325 |
| 3 | 11% | 100% | 300 | 325 |
| 4 | 14% | 100% | 300 | 325 |
| 5 | 18% | 100% | 300 | 325 |
| 6 | 22% | 100% | 300 | 325 |
| 7 | 25% | 100% | 300 | 325 |
| 8 | 29% | 100% | 300 | 325 |
| 9 | 33% | 100% | 300 | 325 |
| 10 | 36% | 100% | 300 | 325 |
| 11 | 40% | 99% | 297 | 322 |
| 12 | 43% | 98% | 295 | 320 |
| 13 | 47% | 96% | 287 | 311 |
| 14 | 51% | 93% | 280 | 303 |
| 15 | 54% | 89% | 268 | 290 |
| 16 | 58% | 85% | 255 | 276 |
| 17 | 61% | 81% | 242 | 262 |
| 18 | 65% | 76% | 228 | 247 |
| 19 | 69% | 72% | 217 | 235 |
| 20 | 72% | 69% | 206 | 223 |
| 21 | 76% | 65% | 196 | 212 |
| 22 | 79% | 62% | 186 | 202 |
| 23 | 83% | 60% | 179 | 194 |
| 24 | 87% | 57% | 172 | 186 |
| 25 | 90% | 55% | 165 | 179 |
| 26 | 94% | 53% | 159 | 172 |
| 27 | 98% | 51% | 152 | 165 |
| 28 | — | — | — | — |
| 29 | — | — | — | — |
| 30 | — | — | — | — |
| 31 | — | — | — | — |

TABLE 1 may be applied to still images. Here, the brightness is not restricted when the emission rate of the pixel unit 100 is no more than about 36%, but it is restricted when the emission rate exceeds about 36%, and the amount of restricted brightness increases as the area in which the pixel unit 100 emits light with the maximum brightness increases. Here, the emission rate is a variable determined by EQUATION 1.

$$Emission rate = \frac{Brightness of one frame}{\begin{matrix}Brightness of pixel unit \\ that emits light in full white\end{matrix}} \qquad [ EQUATION 1 ]$$

In order to prevent excessive restriction on brightness, the maximum restriction rate is restricted to about 50% so that, even if most of the pixels 110 emit light with maximum brightness, the brightness restriction rate is no more than about 50%.

TABLE 2 is a look-up table 220 in which the emission ratio is restricted to about 33% of the maximum value in accordance with the brightness of the pixel unit 100.

TABLE 2

| | | | | Widths of |
|---|---|---|---|---|
| Values of upper | Emission | Emission | Maximum | emission control |
| five bits | rate | ratio | brightness | signals |
| 0 | 0% | 100% | 300 | 325 |
| 1 | 4% | 100% | 300 | 325 |
| 2 | 7% | 100% | 300 | 325 |
| 3 | 11% | 100% | 300 | 325 |
| 4 | 14% | 100% | 300 | 325 |
| 5 | 18% | 99% | 298 | 322 |
| 6 | 22% | 98% | 295 | 320 |
| 7 | 25% | 95% | 285 | 309 |
| 8 | 29% | 92% | 275 | 298 |
| 9 | 33% | 88% | 263 | 284 |
| 10 | 36% | 83% | 250 | 271 |
| 11 | 40% | 79% | 237 | 257 |
| 12 | 43% | 75% | 224 | 243 |
| 13 | 47% | 70% | 209 | 226 |
| 14 | 51% | 64% | 193 | 209 |
| 15 | 54% | 61% | 182 | 197 |
| 16 | 58% | 57% | 170 | 184 |
| 17 | 61% | 53% | 160 | 173 |
| 18 | 65% | 50% | 150 | 163 |
| 19 | 69% | 48% | 143 | 155 |
| 20 | 72% | 45% | 136 | 147 |
| 21 | 76% | 43% | 130 | 141 |
| 22 | 79% | 41% | 124 | 134 |
| 23 | 83% | 40% | 119 | 128 |
| 24 | 87% | 38% | 113 | 122 |
| 25 | 90% | 36% | 109 | 118 |
| 26 | 94% | 35% | 104 | 113 |
| 27 | 98% | 34% | 101 | 109 |
| 28 | — | — | — | — |
| 29 | — | — | — | — |
| 30 | — | — | — | — |
| 31 | — | — | — | — |

TABLE 2 may be applied to moving images. Here, the brightness is not restricted when the emission rate of the pixel unit 100 is no more than about 14%, but it is restricted when the emission rate exceeds about 14%, and the amount of restricted brightness increases as the area in which the pixel unit 100 emits light with the maximum brightness increases. In order to prevent excessive restriction on brightness, the maximum restriction rate is restricted to be about 33% so that, even if most of the pixels 110 emit light with maximum brightness, the brightness restriction rate is no more than about 33%.

The brightness control driver 230 receives data regarding the widths of emission control signals from the look-up table 220 to output brightness control signals. The brightness control signals are input to the scan driver 400, which outputs the emission control signals in accordance with the brightness control signals. In particular, when the scan driver 400 is divided into the scan driving circuit and the emission control circuit, the brightness control signals are input to the emission control circuit, which outputs the emission control signals in accordance with the brightness control signals.

As Table 1 and Table 2 show, the maximum emission period of the emission control signals is set as 325. Since an 8-bit signal can express 256 items, and a 9-bit signal can express 512 items, in order to generate the emission periods of the emission control signals represented in TABLE 1, the brightness control signals are preferably 9-bit signals. Start pulses may be used as the brightness control signals, and the widths of the emission control signals may be determined in accordance with change in the widths of the start pulses.

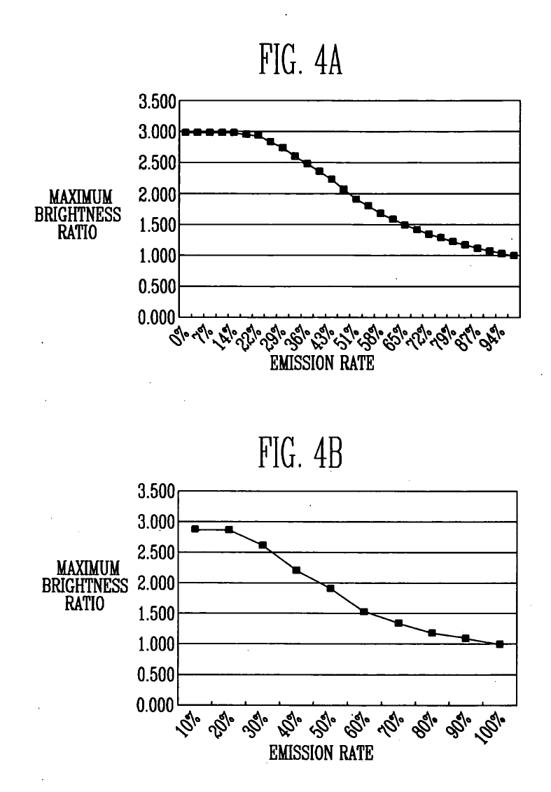

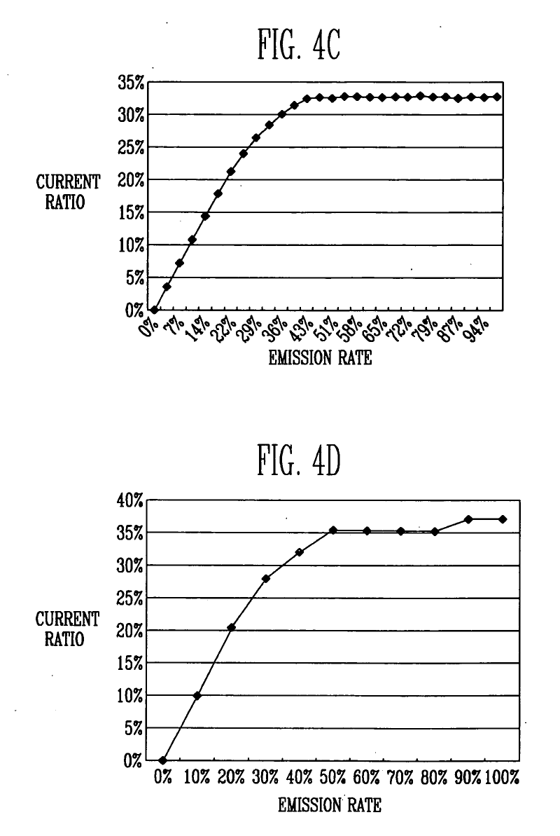

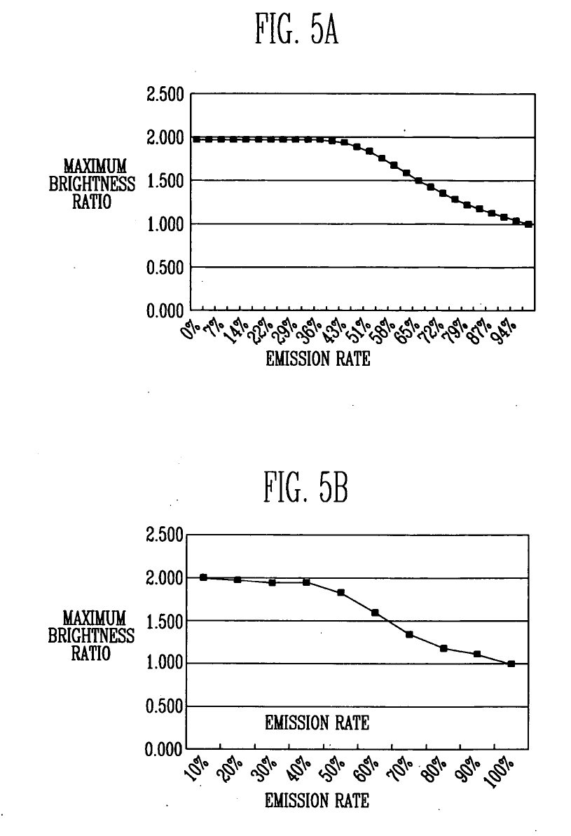

FIG. 4A, FIG. 4B, FIG. 4C and FIG. 4D show cases where the emission ratio of the emission control signals input to the light emitting display according to exemplary embodiments of the present invention is restricted to a maximum of about 33%. FIG. 4A shows the mathematically calculated relationship between emission rates and brightness ratios. FIG. 4B shows the actually measured relationship between emission rates and brightness ratios. FIG. 4C shows the mathematically calculated relationship between emission rates and current ratios. FIG. 4D shows the actually measured relationship between emission rates and current ratios.

Referring to FIG. 4A and FIG. 4B, the brightness ratio is substantially maintained at a predetermined level so that a screen does not become dark when the emission rates are no more than about 30% and may then be gradually reduced so that the screen is not too bright when the emission rates are no less than about 30%.

Referring to FIG. 4C and FIG. 4D, when there is brightness restriction, the amount of currents that flow is about 30 to 35% of the amount of currents that would flow without brightness restriction, thereby reducing the load applied to the power source supply unit 500. Therefore, the power source supply unit 500 does not require high outputs.

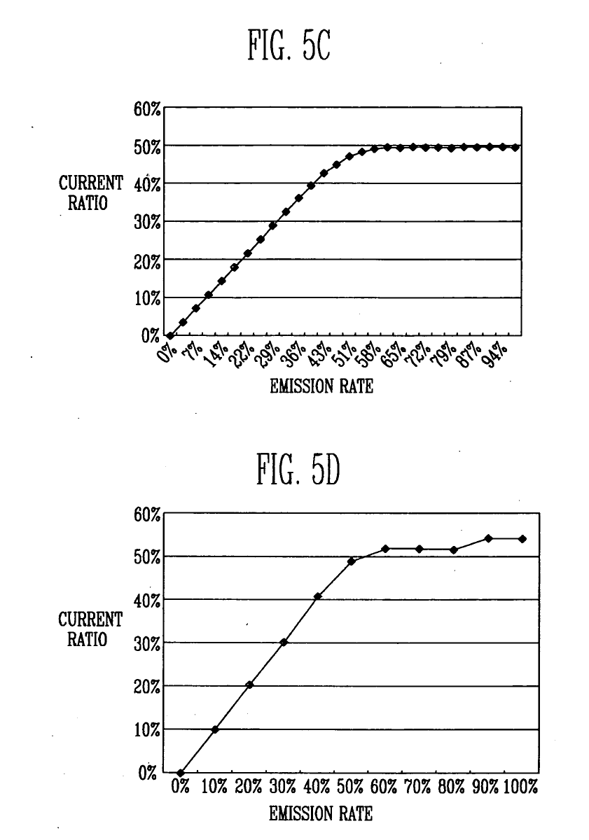

FIG. 5A, FIG. 5B, FIG. 5C, and FIG. 5D show cases where the emission ratio of the emission control signals input to the organic light emitting display according to exemplary embodiments of the present invention is restricted to a maximum of about 50%. FIG. 5A shows the mathematically calculated relationship between emission rates and brightness ratios. FIG. 5B shows the actually measured relationship between emission rates and brightness ratios. FIG. 5C shows the mathematically calculated relationship between emission rates and current ratios. FIG. 5D shows the actually measured relationship between emission rates and current ratios.

Referring to FIG. 5A and FIG. 5B, the brightness ratio is substantially maintained at a predetermined level so that a screen does not become dark when the emission rates are no more than about 40% and may then be gradually reduced so that the screen is not too bright when the emission rates are no less than about 40%.

Referring to FIG. 5C and FIG. 5D, when there is brightness restriction, the amount of currents that flow is about 50% of the amount of currents that would flow without brightness restriction, thereby reducing the load applied to the power source supply unit 500. Therefore, the power source supply unit 500 does not require high outputs.

In an organic light emitting display according to exemplary embodiments of the present invention and a method of driving the same, the flow of currents is restricted in accordance with the emission rate of the organic light emitting display so that it is possible to reduce power consumption. Therefore, it may be possible to improve picture quality, and a power source supply unit having high outputs may not be required.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An organic light emitting display, comprising:
a pixel unit including pixels receiving scan signals, emission control signals, and data signals to display images;
a brightness controller to restrict brightness of the pixel unit;
a scan driver to transmit the scan signals and the emission control signals to the pixel unit; and
a data driver to generate the data signals using video data and to transmit the data signals to the pixel unit,
wherein the brightness controller generates frame data by summing the video data in one frame, and the brightness of the pixel unit is restricted when a magnitude of the frame data is no less than a first value and is not restricted when the magnitude of the frame data is no more than a second value.

2. The organic light emitting display of claim 1, wherein the brightness of the pixel unit is controlled by a width of the emission control signals.

3. The organic light emitting display of claim 1, wherein the brightness controller comprises:
a data summing unit to sum the video data in the one frame to generate the frame data;
a look-up table to store emission information on emission time of the pixels in accordance with the frame data; and
a brightness control driver to transmit brightness control signals for controlling the emission control signals in accordance with the emission information.

4. The organic light emitting display of claim 3, wherein the scan driver receives the brightness control signals to generate the emission control signals.

5. The organic light emitting display of claim 4, wherein the scan driver comprises:
a scan driving circuit to transmit the scan signals; and
an emission control driving circuit to transmit the emission control signals.

6. The organic light emitting display of claim 1, further comprising:
a power source supply unit to transmit a driving power source that drives the pixel unit.

7. The organic light emitting display of claim 1, wherein the restriction of brightness of the pixel unit varies with the type of image displayed by the pixel unit.

8. An organic light emitting display, comprising:
a pixel unit including pixels receiving scan signals, emission control signals, and data signals to display images;
a brightness controller to restrict the brightness of the pixel unit;
a scan driver to transmit the scan signals and the emission control signals to the pixel unit; and
a data driver to generate the data signals using video data and to transmit the data signals to the pixel unit,
wherein the brightness controller generates frame data by summing the video data in one frame, and
wherein brightness restriction of the pixel unit changes with the magnitude of the frame data.

9. The organic light emitting display of claim 8, wherein the brightness of the pixel unit is controlled by a width of the emission control signals.

10. The organic light emitting display of claim 8, wherein the brightness controller comprises:
a data summing unit to sum the video data in the one frame to generate the frame data;
a look-up table to store emission information on the emission time of the pixels in accordance with the frame data; and
a brightness control driver to transmit brightness control signals for controlling the emission control signals in accordance with the emission information.

11. The organic light emitting display of claim 10, wherein the scan driver receives the brightness control signals to generate the emission control signals.

12. The organic light emitting display of claim 11, wherein the scan driver comprises:
a scan driving circuit to transmit the scan signals; and
an emission control driving circuit to transmit the emission control signals.

13. The organic light emitting display of claim 8, further comprising:
a power source supply unit to transmit a driving power source that drives the pixel unit.

14. The organic light emitting display of claim 8, wherein the restriction of brightness of the pixel unit varies with the type of image displayed by the pixel unit.

15. A method of driving an organic light emitting display, comprising:
summing video data input in one frame; and
restricting brightness of a pixel unit when the magnitude of the summed data is no less than a first level, and not restricting the brightness of the pixel unit when the magnitude of the summed data is no more than a second level.

16. The method of claim 15, further comprising:
determining a length of an emission period in which the pixel unit emits light in accordance with the magnitude of the summed data.

17. The method of claim 16, wherein the length of the emission period is determined using a look-up table that contains the length of the emission period corresponding to the magnitude of the summed data.

18. The method of claim 17, further comprising:
varying a brightness restriction amount according to the type of image displayed by the pixel unit.

19. The method of claim 15, further comprising:
varying a pulse width of an emission control signal to restrict the brightness of the pixel unit.
